(19) United States
(12) Patent Application Publication
(10) Pub. No.: US 2011/0181638 A1
(43) Pub. Date: Jul. 28, 2011

(54) Inkjet print head assembly and ink supply method thereof

(75) Inventors: Sung Wook Kim, Suwon (KR); Jong Beom Kim, Yongin (KR); Seung Mo Lim, Suwon (KR)

(73) Assignee: SAMSUNG ELECTRO-MECHANICS CO., LTD., Suwon (KR)

(21) Appl. No.: 12/926,528

(22) Filed: Nov. 23, 2010

(30) Foreign Application Priority Data
Jan. 22, 2010 (KR) 10-2010-0005924

(51) Int. Cl. B41J 2/195; B41J 2/175

(52) U.S. Cl. 347/7; 347/86

(57) ABSTRACT

An inkjet print head assembly includes: an ink tank storing ink provided from the exterior; a partition demarcating the interior of the ink tank; a tank head including at least two ink movement holes allowing ink to flow into the interior of the ink tank therethrough and a common channel communicating with the ink movement holes; and an inkjet print head coupled to the tank head to discharge the ink from the common channel.

### CROSS-REFERENCE TO RELATED APPLICATIONS

This application claims the priority of Korean Patent Application No. 10-2010-0005924 filed on Jan. 22, 2010, in the Korean Intellectual Property Office, the disclosure of which is incorporated herein by reference.

### BACKGROUND OF THE INVENTION

1. Field of the Invention

The present invention relates to an inkjet print head assembly capable of preventing the generation of bubbles in ink stored in a common channel within a tank head connected to an inkjet print head, and an ink supply method thereof.

2. Description of the Related Art

In general, an inkjet print head is a structure for converting an electrical signal into a physical force to allow ink to be discharged dropwise through a small nozzle. In particular, an inkjet head assembly includes an inkjet print head having a nozzle plate and an ink tank that supplies ink to the inkjet print head.

Recently, a piezoelectric inkjet head has been employed for industrial inkjet printers. For example, the piezoelectric inkjet head is used to jet ink generated by melting metal such as gold, silver, and the like, onto a printed circuit board to directly form a circuit pattern, or is used for industrial graphics, in manufacturing a liquid crystal display (LCD) and an organic light emitting diode (OLED), or used for the production of solar cells, and the like.

The ink tank communicates with (or is connected to) a tank head on which the inkjet print head is mounted. The tank head includes a common channel communicating with an inlet of the inkjet print head.

The common channel of the tank head stores ink therein, and in this case, an air bubble trap phenomenon occurs. That is, air is trapped in the common channel in the course of filling the common channel with ink.

The air bubble trap results in an abnormal discharge of ink because air bubbles are mixedly introduced to a flow path within the head according to a flow of ink.

Thus, in order to remove the air bubble trap, a drain port is installed within the tank head. However, the installation of the drain port leads to the necessity of a valve, and the value requires a controlling/mechanical part, and the like, to switch the valve.

In addition, the switching of the valve consumes a great quantity of ink.

### SUMMARY OF THE INVENTION

An aspect of the present invention provides an inkjet print head assembly capable of preventing the generation of bubbles in ink stored in a common channel within a tank head communicating with an inkjet print head.

Another aspect of the present invention provides an ink supply method capable of preventing the generation of bubbles in ink stored in a common channel within a tank head connected to an inkjet print head.

According to an aspect of the present invention, there is provided an inkjet print head assembly including: an ink tank storing ink provided from the exterior; a partition demarcating the interior of the ink tank; a tank head including at least two ink movement holes allowing ink to flow therethrough into the interior of the ink tank and a common channel communicating with the ink movement holes; and an inkjet print head coupled to the tank head to discharge the ink from the common channel.

The common channel may be formed to slope between the ink movement holes.

The ink tank may include an ink supply port communicating with an external ink supply source, and the ink supply port may be formed at a position lower than the height of the partition.

The ink tank may include a first ink level sensor measuring the level of ink stored in a first space within the partition after the ink is provided through the ink supply port.

The ink tank may include a second ink level sensor measuring the level of ink stored in a second space within the partition after the ink is introduced to the ink tank through at least one of the ink movement holes from the common channel.

The ink tank may include a third ink level sensor measuring the level of ink stored at an upper side of the partition.

The ink tank may include a pressure discharge port communicating with the exterior, and the pressure discharge port may be formed at a position higher than the height of the partition.

According to another aspect of the present invention, there is provided an ink supply method including: providing ink to an ink supply port formed in a first space within an ink tank demarcated by a partition in a first process; when the ink filled in the first space is sensed by a first ink level sensor, stopping ink supply, and when a lowered ink level in the first space is sensed while the ink flows along a sloped common channel within a tank head, providing ink again in a second process; performing the second process until such time as ink filled in a second space within the ink tank is sensed by a second ink level sensor in a third process; and when ink is sensed by the first and second ink level sensors, additionally supplying ink until such time as the level of the ink is sensed by a third ink level sensor formed at an upper side of the partition in a fourth process.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a partially cut-away inkjet print head assembly according to an exemplary embodiment of the present invention;

FIG. 2 is a schematic sectional view of the inkjet print head assembly according to an exemplary embodiment of the present invention; and

FIGS. 3 to 5 are sectional views for explaining a method for supplying ink to the inkjet print head assembly according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

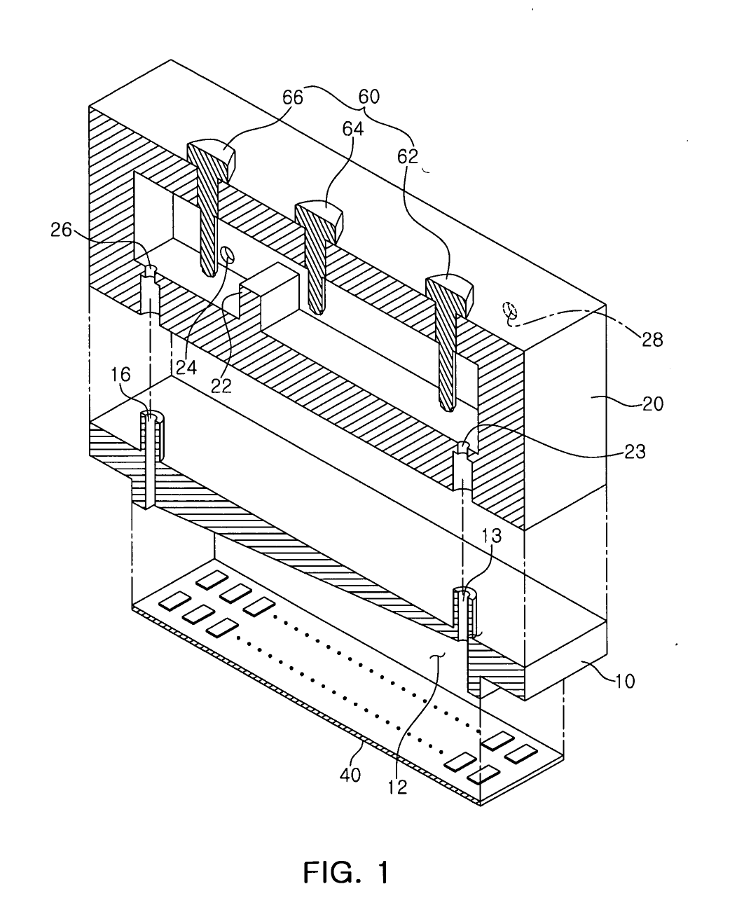

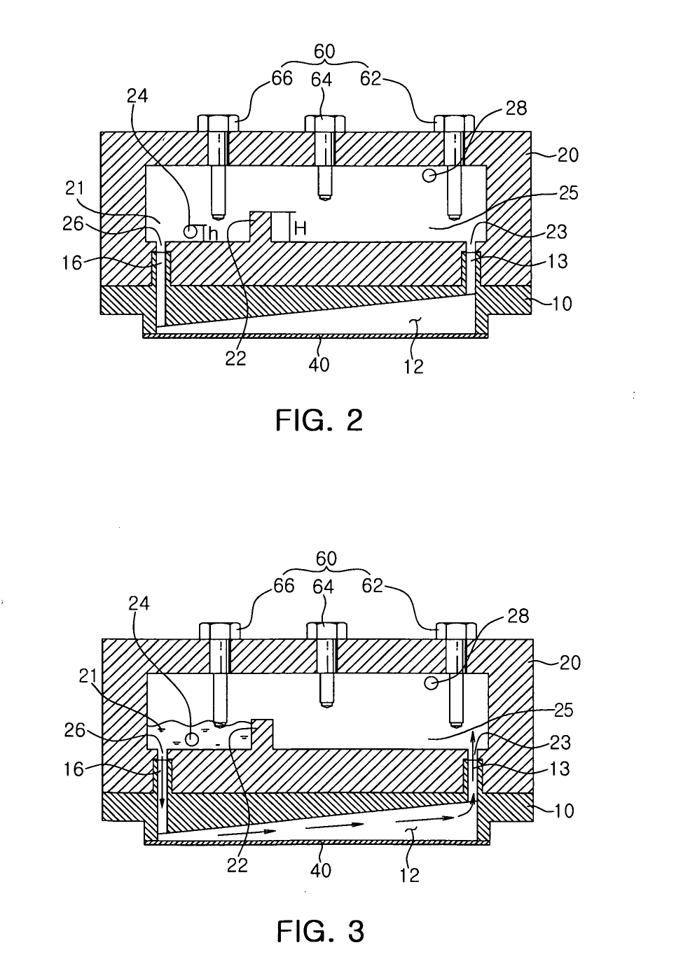

FIG. 1 is a schematic perspective view showing a partially cut-away inkjet print head assembly according to an exemplary embodiment of the present invention. FIG. 2 is a schematic sectional view of the inkjet print head assembly according to an exemplary embodiment of the present invention.

With reference to FIGS. 1 and 2, an inkjet print head assembly according to an exemplary embodiment of the present invention may include an ink tank 20, a partition 22, a tank head 10, and an inkjet print head 40.

The ink tank 20 includes a space for storing ink supplied from an external ink supply source. The internal space of the ink tank 20 may be demarcated into two spaces by the partition 22.

The tank head 10, on which the inkjet print head 40 is mounted, may be coupled to the ink tank 20. The tank head 10 may include at least two ink movement holes 13 and 16 communicating with the ink tank 20. Also, the tank head 10 may include a common channel 12 communicating with the ink movement holes 13 and 16.

Here, in the present exemplary embodiment, the ink movement holes 13 and 16 are separately formed based on the partition 22, but the present invention is not meant to be limited thereto and a plurality of ink movement holes may be formed to communicate with both spaces 21 and 25 based on the partition 22, all of which may communicate with the common channel 12.

The ink movement holes 13 and 16 communicate with communication holes 23 and 26 formed in the ink tank 20, respectively.

An ink supply port 24 is formed in the first space 21, among the two spaces of the ink tank 20, which communicates with an external ink supply source to allow ink to be introduced therethrough. Here, the ink supply port 24 may be formed at a position having a height (h) lower than a height (H) of the partition 22 of the ink tank 20.

The ink tank 20 may include a plurality of ink level sensors 60 that measure the level of ink stored in the ink tank 20.

The ink tank 20 may include a first ink level sensor 66 for measuring the level of ink, upon being provided from the ink supply port 24, stored in the first space 21 within the partition 22.

Also, the ink tank 20 may include a second ink level sensor 62 for measuring the level of ink, upon being introduced to the ink tank 20 through at least one 13 of the ink movement holes 13 and 16 from the common channel 12, stored in the second space 25 within the partition 22.

Also, the ink tank 20 may include a third ink level sensor 64 for measuring the level of ink stored in an upper space of the partition 22.

The ink flow in the ink tank 20 and the tank head will now be described briefly. First, when ink is introduced into the ink tank 20 through the ink supply port 24 in the ink tank 20 from an external supply source, the ink is stored in the first space 21 and moves (or flows) along the common channel 12 of the tank head 10 through the ink movement hole 16 formed at one side of the tank head 10. The ink flowing along the common channel 12 moves to the ink tank 20 through the ink movement hole 13 formed at the other side of the tank head 10 and then stores in the second space 25.

Here, in order to prevent the generation of bubbles in the ink within the common channel 12, the common channel 12 may be formed to slope between the ink movement holes 13 and 16.

In this case, the common channel 12 slopes from the first space 21 to the second space 25 to allow bubbles to be easily released into the second space 25.

In addition, a pressure discharge port 28 communicating with the exterior is formed within the ink tank 20. In this case, the pressure discharge port 28 is formed at a position higher than the height (H) of the partition 22.

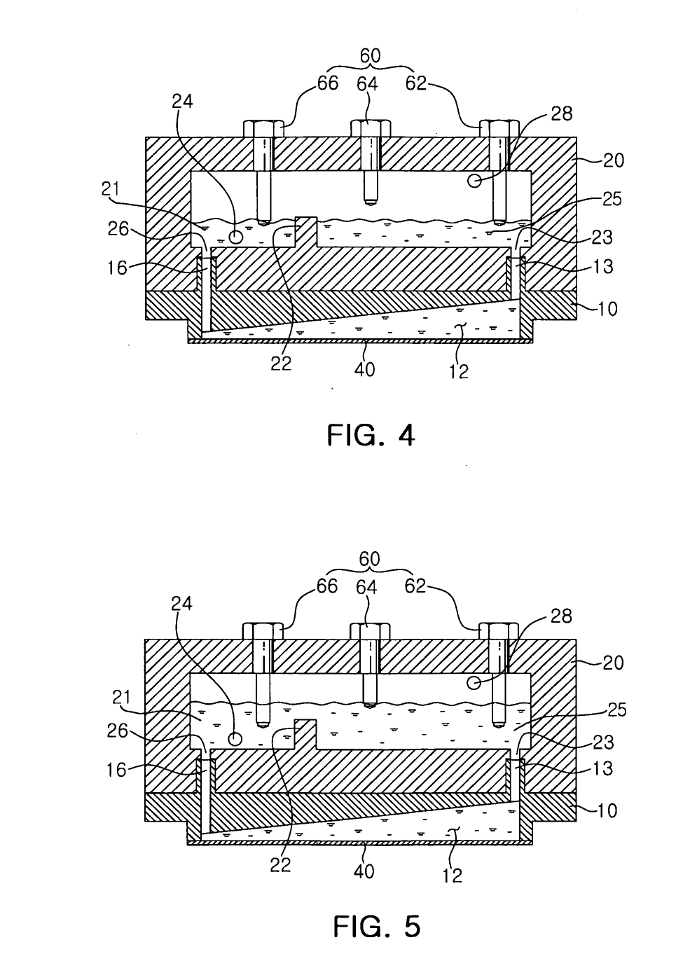

FIGS. 3 to 5 are sectional views for explaining a method for supplying ink to the inkjet print head assembly according to an exemplary embodiment of the present invention.

A method for supplying ink to the interior of the ink tank 20 such that no bubbles are generated in the ink in the common channel 12 of the tank head 10 of the inkjet print head assembly according to an exemplary embodiment of the present invention will now be described in detail.

First, as shown in FIG. 3, ink is provided to the ink supply port 24 formed in the first space 21 within the ink tank 20 demarcated by the partition 22.

When the ink filled in the first space 21 is sensed by the first ink level sensor 66, the ink supply is stopped. In this case, the ink moves to the common channel 12 within the tank head 10 through the ink movement hole 16 formed at tone side of the tank head 10 and then moves to the second space 25 of the ink tank 20 through the ink movement hole 16 formed at the other side of the tank head 10.

Because the ink moves to the second space of the ink tank 20 in a state in which the ink supply is stopped, the reduced ink level in the first space is sensed by the first ink level sensor 66.

As the ink level is lowered, as shown in FIG. 4, ink is provided through the ink supply port 24 again, and ink supply and interruption are repeatedly performed until such time as the ink filled in the second space 25 within the ink tank. 20 is sensed by the second ink level sensor 62. Here, ink is supplied to fill in the first and second spaces 21 and 25 such that it does not overflow the partition 22.

When ink is sensed by the first and second level sensors 66 and 62, ink is additionally supplied until such time as its level is sensed by the third ink tank sensor 64 formed at the upper side of the partition 22.

Thereafter, the ink is used by using the inkjet print head 40. At this time, because the ink is simultaneously supplied through the ink movement holes 13 and 16 formed in the tank head 10, uniform pressure is applied to the entirety of the inkjet print head 40.

As set forth above, in the inkjet print head assembly and an ink supply method thereof according to exemplary embodiments of the invention, because the common channel is formed to slope within the tank head, air bubbles can smoothly flow into the ink tank, thus preventing a generation of an air bubble trap caused as air is trapped within ink present in the common channel.

In addition, because there is no air bubble trap, air cannot move to the inkjet print head from the common channel, and accordingly, ink quality can be improved.

Also, because there is no need to install a drain port within the tank head to remove an air bubble trap and a controlling/mechanical part for switching a valve are not required, the inkjet print head assembly can be fabricated easily and economically.

Moreover, because ink is provided to the head through a plurality of ink supply paths from the ink tank, a supply resistance at the ink tank can be reduced to facilitate high frequency discharging. Furthermore, because ink is provided through the plurality of ink supply paths, a problem arising as the discharge amount varies as flow resistances are different at nozzle positions can be solved.

Furthermore, because the flow resistance is uniform overall, the inkjet print head assembly according to the present invention is effective for the s fields of application such as displays, electronic circuits, and the like, in which the ink discharge amount must be uniform.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head assembly comprising:
an ink tank storing ink provided from the exterior;
a partition demarcating the interior of the ink tank;
a tank head including at least two ink movement holes allowing ink to flow therethrough into the interior of the ink tank and a common channel communicating with the ink movement holes; and
an inkjet print head coupled to the tank head to discharge the ink from the common channel.

2. The inkjet print head assembly of claim 1, wherein the common channel is formed to slope between the ink movement holes.

3. The inkjet print head assembly of claim 1, wherein the ink tank comprises an ink supply port communicating with an external ink supply source, and the ink supply port is formed at a position lower than the height of the partition.

4. The inkjet print head assembly of claim 3, wherein the ink tank comprises a first ink level sensor measuring the level of ink stored in a first space within the partition after the ink is provided through the ink supply port.

5. The inkjet print head assembly of claim 3, wherein the ink tank comprises a second ink level sensor measuring the level of ink stored in a second space within the partition after the ink is introduced to the ink tank through at least one of the ink movement holes from the common channel.

6. The inkjet print head assembly of claim 1, wherein the ink tank comprises a third ink level sensor measuring the level of ink stored at an upper side of the partition.

7. The inkjet print head assembly of claim 1, wherein the ink tank comprises a pressure discharge port communicating with the exterior, and the pressure discharge port is formed at a position higher than the height of the partition.

8. An ink supply method comprising:
providing ink to an ink supply port formed in a first space within an ink tank demarcated by a partition in a first process;
when the ink filled in the first space is sensed by a first ink level sensor, stopping ink supply, and when a lowered ink level in the first space is sensed while the ink flows along a sloped common channel within a tank head, providing ink again in a second process;
performing the second process until such time as ink filled in a second space within the ink tank is sensed by a second ink level sensor in a third process; and
when ink is sensed by the first and second ink level sensors, additionally supplying ink until such time as the level of the ink is sensed by a third ink level sensor formed at an upper side of the partition in a fourth process.
